(19) United States
(12) Patent Application Publication
(10) Pub. No.: US 2004/0080447 A1
(43) Pub. Date: Apr. 29, 2004

(54) Miniature omni-directional corner reflector

(76) Inventor: Christophe F. Bas, Tyngsborough, MA (US)

Correspondence Address: Choate, Hall & Stewart, Exchange Place, 53 State Street, Boston, MA, 02109, US

(21) Appl. No.: 10/686,804

(22) Filed: Oct. 16, 2003

Related U.S. Application Data
(60) Provisional application No. 60/419,155, filed on Oct. 17, 2002.

(51) Int. Cl. H01Q 15/18

(52) U.S. Cl. 342/5; 342/7

(57) ABSTRACT

Method and apparatus for a miniature omni-directional corner reflector (MOCR) and an array thereof. In one aspect, the invention comprises the application of MOCRs in an amorphous configuration to produce a reflective coating. The geometry, matter, and size dictate the principle behavior of the MOCR to reflect incident electromagnetic radiation back toward the source of illumination. The omni-directionality topology, miniature size, and powder form of individual MOCRs eliminates the need for a particular orientation of individual MOCRs when applied as a reflective coating or layer to a desired object or structure.

### CROSS-REFERENCE TO RELATED APPLICATIONS

The present application claims priority to U.S. Provisional Application No. 60/419,155, filed Oct. 17, 2002, the teachings of which are incorporated herein by reference.

### FIELD OF THE INVENTION

The present invention relates to the field of corner reflectors and more particularly to a method and apparatus for a miniature omni-directional corner reflector, an array thereof, and applications therefor.

### BACKGROUND OF THE INVENTION

Corner reflector structures are known in the art as means for reflecting electromagnetic radiation (energy or field strength), including radar, laser and optical light, back towards the source of the energy. Corner reflectors in multiple configurations have been used for navigational, informational and other purposes on boats, signs, and other structures, including the Moon on which astronauts positioned a corner cube reflector array during NASA's Apollo space program. Generally, corner reflectors used for these purposes are static structures on the order of tens of centimeters in size.

Most corner reflectors are variations on the 3-sided corner reflector, also known as a corner cube or a trihedral reflector. The principal reflected electromagnetic radiation, termed “echo”, from a trihedral reflector will be strongest when its “pocket” is oriented directly towards the incident electromagnetic radiation. As the trihedral reflector is rotated off this axis in any direction, the echo becomes weaker, and drops by half at an angle of 12° to 20° from the axis of symmetry, depending on its specific shape. With increased rotation, the return continues to drop to almost zero as one of the three sides approaches an edge-on attitude to the incident electromagnetic radiation. To improve omni-directionality, an octahedral reflector may be utilized that generally comprises eight trihedral reflectors configured to reflect incident electromagnetic radiation back toward an illumination source from any direction. For examples of corner reflector configurations, see U.S. Pat. Nos.: 5,097,265 to Aw; 4,996,536 to Broadhurst; 4,551,726 to Berg; 4,503,101 to Bennett; 4,241,349 to Connell and PCT Publication WO 01/46721 to Strawbrich et al., the teachings of all of which are incorporated herein by reference.

Corner reflectors having miniature size have also been disclosed in the prior art. U.S. Pat. No. 6,010,223 to Gubela, incorporated herein by reference, discloses a sensor system based on the retroreflection of a laser beam in which the individual micro reflector elements have diameters in the range of 0.002 to 0.8 mm. The micro reflector elements in Gubela's sensor system are attached to one another to form a static and rigid array surface that limits the angular effectiveness of the reflected beam.

There remains a need for corner reflectors that are miniature in size, operate independent of orientation, and which can be applied and utilized in an amorphous and flexible configuration.

### SUMMARY OF THE INVENTION

The present invention discloses a method and apparatus for a miniature omni-directional corner reflector (MOCR) and an array thereof. In one aspect, the invention comprises the application of MOCRs in an amorphous configuration to produce a reflective coating. The geometry, matter, and size dictate the principle behavior of the MOCR to reflect incident electromagnetic radiation back toward the source of illumination. The omni-directional topology, miniature size, and powder form of individual MOCRs eliminates the need for a particular orientation of individual MOCRs when applied as a reflective coating or layer to a desired product or structure.

### BRIEF DESCRIPTION OF THE DRAWING

The invention is described with reference to the several figures of the drawing, in which:

FIG. 1 illustrates various corner reflector topologies including geometries and angular response information;

FIG. 2 is an perspective view of an octahedral MOCR in a reflective coating according to one embodiment of the invention;

FIG. 3 is a schematic illustration of the random and independent positioning and orientation of multiple MOCRs within a reflective coating according to one embodiment of the invention;

FIGS. 4A and 4B are graphs illustrating spectral returns for various optical materials.

### DETAILED DESCRIPTION OF THE VARIOUS EMBODIMENTS

According to one embodiment of the present invention, a miniature omni-directional corner reflector (MOCR) and array thereof are disclosed having physical properties that contribute to the overall behavior of the invention. The geometry, size, and material of the MOCR dictate its behavior whose purpose is to reflect incident electromagnetic radiation back toward the source of illumination.

Referring now to the figures of the drawing, the figures constitute a part of this specification and illustrate exemplary embodiments of the invention. It is to be understood that in some instances various aspects of the invention may be shown exaggerated or enlarged to facilitate an understanding of the invention.

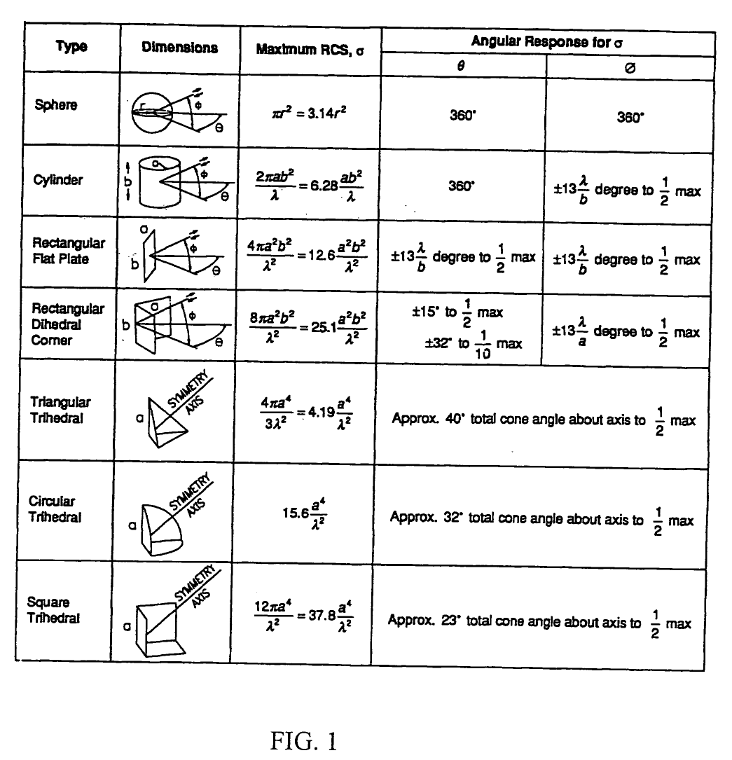

The omni-directional corner reflector topology ensures that the primary reflective property remains independent of the orientation of the MOCR. Electromagnetic radiation (for example, in the optical range) is reflected back towards the source of illumination regardless of how the MOCR is oriented or of the direction of the incident electromagnetic radiation. In one embodiment, the omni-directional topology is an octahedral configuration comprised of eight trihedral reflectors; however, non-trihedral based topologies are also possible as known to those of ordinary skill in the art. Various topologies for corner reflectors are shown in FIG. 1 which includes data on the maximum radar cross section (RCS) and the angular response. (See J. Corenman, C. Hawley, D. Honey & S. Honey, 1995 Radar Reflector Test, at <http://Hwww.ussailing.org/safety/studies/radar_reflector_test.htm>, the teachings of which are incorporated herein by reference.)

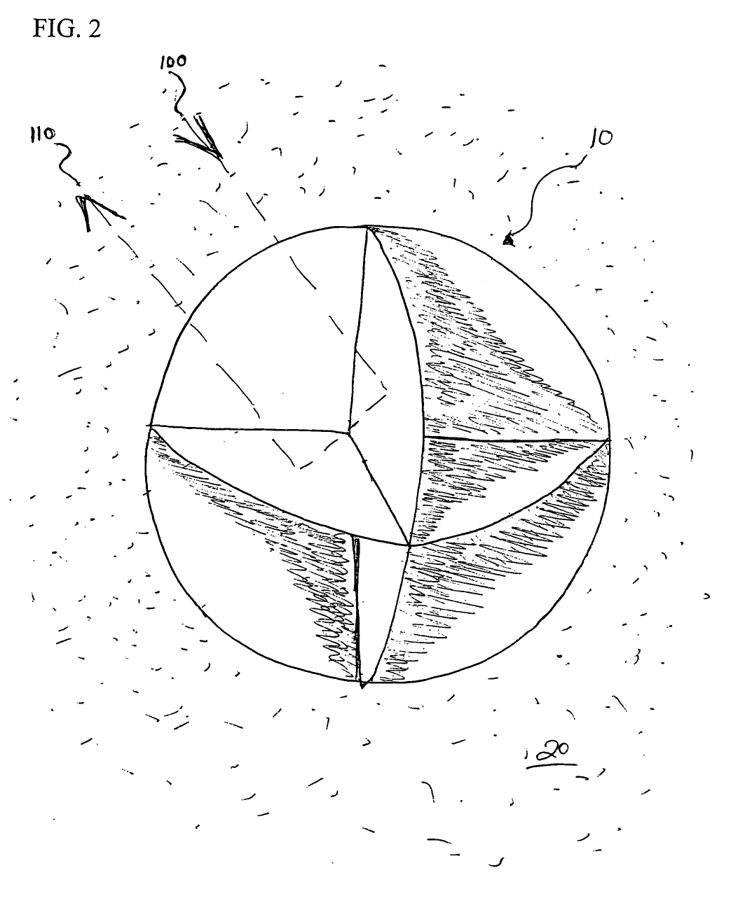

FIG. 2 is a perspective view of an octahedral MOCR 10 in a reflective coating or other binding medium 20 according to one embodiment of the invention. Incident electromagnetic radiation 100 strikes the MOCR 10 and reflected electromagnetic radiation 110 is directed back toward the illumination source is shown. The classic octahedral reflector is made of three planar circles or squares of metal intersecting at right angles, forming eight trihedral reflectors. In the usual “catch rain” position, one trihedral will face up and one down, and the remaining six are arrayed around a circle, three oriented 18° above the equator, and three 18° below. This optimizes the return from the “pockets”, and avoids the nulls or gaps as best as is possible, but only at a 0° angle of heel. In the present invention, the MOCR is positioned within a reflective coating, binding medium or reflective layer such that each individual MOCR is oriented randomly and independently of other surrounding MOCRs. This enables incident electromagnetic radiation striking an object covered with MOCRs to be reflected back towards an illumination source with at least of portion of the reflected electromagnetic radiation being optimally returned regardless of the position of the illumination source with respect to the object.

The miniature size of the MOCR ensures its integration in high numbers when applied in a desired environment. In one embodiment, individual MOCR elements have characteristic dimensions in the range of approximately 1 micrometer to approximately 100 micrometers, and more preferably characteristic dimensions of approximately 10 micrometers.

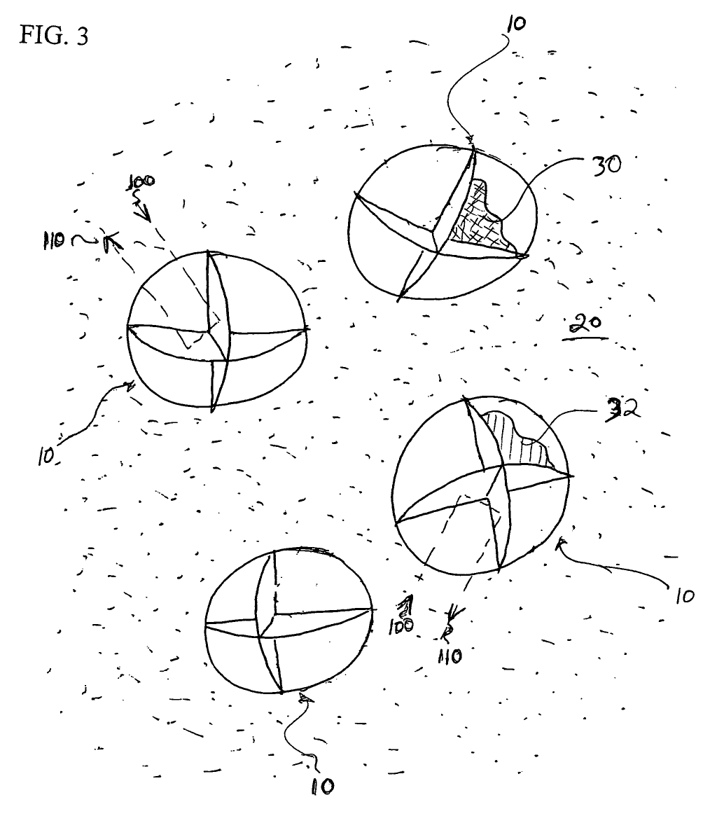

The miniature size of the MOCR is suitable for manufacture in a raw powder or dust form. As a powder, the MOCRs may be mixed with a coating substance, for example paint, to form a reflective coating mixture. This reflective coating mixture may be applied in an amorphous configuration to form a reflecting coating that does not maintain a rigid array or structure. The application of the reflective coating mixture is done with random orientation of the MOCRs in that there is no need for ensuring individual MOCRs in the coating have any particular orientation with respect to one another. FIG. 3 is a schematic illustration of the positioning and orientation of individual MOCRs 10 within the reflective coating 20. The MOCRs 10 are oriented independently of one another within the reflective coating 20. Incident electromagnetic radiation 100 strikes a MOCR 10 and reflected electromagnetic radiation 110 is directed back toward the source of illumination, regardless of the position of the illumination source, due to the random and independent orientation of multiple MOCRs.

Microproduction and microfabrication techniques have been extensively developed and refined in the electronics industry, as for example with micro electromechanical systems (MEMS). Micro-scale processing techniques include electron injection, deposition, and etching, among others. (For a few of the myriad examples of microfabrication technology and materials, see U.S. Pat. Nos. 6,277,666 to Hays et al; 6,185,107 to Wen; and 5,641,391 to Hunter et al.; the teachings of all of which are incorporated herein by reference.) Such techniques can be utilized to produce a high volume of MOCRs at a low cost per unit. In one embodiment, MOCRs are produced in the micrometer size range; however, it is also possible to produce MOCRs on smaller scales, i.e. in the nanometer range, by utilizing the growing industry of nano-technology processing techniques. (See, for example, 6,294,401 to Jacobsen et al., the teachings of which are incorporated herein by reference.)

A reflective coating according to the present invention could be applied as a highly reflective paint to such articles or structures as landing strips, road signs, or work areas. The reflective coating is flexible and could be incorporated into fibers to form highly reflective clothing, and could also be used in other commercial products, such as magnets, stickers, and insignias to name only a few examples. The present invention may be applied by multiple methods and can thus potentially be sprayed, painted or embedded onto a surface. In another embodiment, the present invention may be utilized to specifically mark objects in the non-visible electromagnetic spectrum, as for example in the budding technologies of road recognition systems and automobile autopilots.

The material of which each MOCR is made helps control the frequency response of the MOCR. The presence of MOCRs having diverse properties and densities results in a controlled reflectivity (or observed brightness upon illumination) of the environments incorporating them. By varying combinations of materials, control of the frequency response of each MOCR is attained. In another embodiment, materials may be deposited onto the MOCR structure to control frequency response. FIG. 3 illustrates material layers 30 and 32 applied to MOCRs 10 in the reflective coating 20.

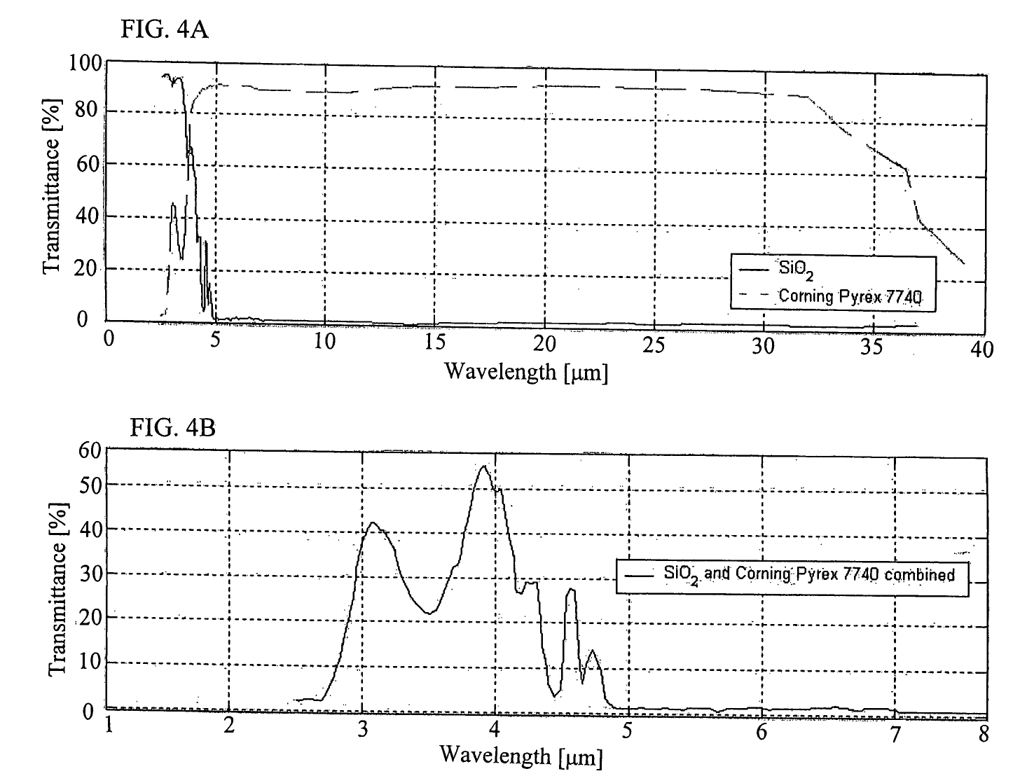

ALS, a division of Berkeley Laboratory, has tabulated the transmittance of several optical materials over a range of wavelengths. (See Infrared Window Materials at <http://infrared.als.lbl.gov/IRwindows.html>, the teachings of which are incorporated herein by reference.) One example, from this table, consists in observing the limited spectral span of a sample of Corning Pyrex 7740 having a thickness of 2.06 mm, as shown in FIG. 4A. In multiple embodiments, a MOCR could be either coated with the optical material or inserted into a droplet of it to exhibit a spectral return close to that of the optical material.

Another example consists in combining materials. For instance, the MOCR could first be coated with some SiO2 and then coated with (or inserted into a droplet of) some Corning Pyrex 7740. FIG. 4A illustrates the transmittances of SiO2 and Corning Pyrex 7740 over a range of wavelengths. The resulting spectral return from a combination of these materials (ignoring chemical compatibility issues), as could be applied to a MOCR, is shown in FIG. 4B.

The thickness of the coating affects the amount of spectral attenuation exhibited by a coated MOCR. This relationship (known as the Lambert-Beer law) may be used as a mechanism to control the amount of attenuation inflicted to a given wavelength. The material from which a MOCR is made can also affect the spectral response. The material which binds all the MOCRs together could either be transparent to the wavelengths of interest or have a frequency-response of its own (e.g., paint).

As noted above with respect to FIG. 4B, individual MOCRs may be coated with several layers of materials before being integrated into a binding medium. In another embodiment, the binding medium may combine MOCRs of various material coatings (e.g., 30% SiO2, 40% Pyrex, 30% uncoated - - - see FIG. 3) to provide enhanced control of frequency response.

In yet another embodiment, the individually coated MOCRs could be pulverized as in a spray where an inert gas would expel the MOCRs from the can. In this case, a sticky surface could be described as the binding medium. In other embodiments, it may be preferable to apply the MOCRs in a manner that allows the MOCRs to float in the air (e.g., tracers for turbulent-flow analysis).

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A corner reflector, comprising:
a reflective structure having an omni-directional topology that reflects incident electromagnetic radiation back towards an illumination source, wherein said reflecting structure is of miniature size and adapted for orientation independent of any adjacent reflective structures.

2. The reflector of claim 1, wherein said corner reflector is in powder form.

3. The reflector of claim 1, wherein said corner reflector has a characteristic dimension in a range of about 1 micrometer to about 100 micrometers.

4. The reflector of claim 3, wherein said characteristic dimension is about 10 micrometers.

5. The reflector of claim 1, wherein said reflective structure is coated with at least one material layer that provides a controlled frequency response.

6. The reflector of claim 5, wherein said reflector is coated with at least two different material layers.

7. An array of reflectors, comprising:
at least two reflective structures, wherein said reflective structures have an omni-directional topology that reflects incident electromagnetic radiation back towards an illumination source, and wherein each of said at least two reflective structures are oriented independently of one other.

8. The array of claim 7, wherein said at least two reflective structures are in powder form.

9. The array of claim 7, wherein each reflective structure has a characteristic dimension in a range of about 1 micrometer to about 100 micrometers.

10. The array of claim 9, wherein said characteristic dimension is about 10 micrometers.

11. The array of claim 7, wherein said at least one of said reflective structures are coated with at least one material layer.

12. The array of claim 11, wherein each of said at least two reflective structures are coated with a different material layer.

13. The array of claim 7, wherein said at least two reflective structures are mixed in a binding medium.

14. A reflective article, comprising:
a binding medium, and
at least two reflective structures attached to said binding medium, wherein said reflective structures have an omni-directional topology that reflects incident electromagnetic radiation back towards an illumination source, and wherein each of said at least two reflective structures are oriented independently of one other.

15. The article of claim 14, wherein said at least two reflective structures are in powder form.

16. The article of claim 14, wherein each reflective structure has a characteristic dimension in a range of about 1 micrometer to about 100 micrometers.

17. The article of claim 16, wherein said characteristic dimension is about 10 micrometers.

18. The article of claim 14, wherein said at least two reflective structures are attached to said binding medium as part of an applied coating.

19. The article of claim 14, wherein said at least two reflective structures are embedded in said binding medium.

20. The article of claim 14, wherein said binding medium is a flexible material layer.

21. A method for producing a reflective coating, comprising:
applying a plurality of miniature omni-directional corner reflectors in a desired manner, wherein each reflector of said plurality of miniature omni-directional corner reflectors is oriented independently of surrounding reflectors.

22. The method of claim 21, wherein said plurality of miniature omni-directional corner reflectors are in power form.

23. The method of claim 21, wherein each reflector in said plurality miniature omni-directional corner reflectors has a characteristic dimension in a range of about 1 micrometer to about 100 micrometers.

24. The method of claim 23, wherein said characteristic dimension is about 10 micrometers.

25. The method of claim 21, wherein said material layer is a flexible material layer.

26. The method of claim 21, further comprising:
coating at least one of said plurality of miniature omni-directional corner reflectors with at least one material layer.

27. The method of claim 26, wherein said plurality of miniature omni-directional corner reflectors are coated with at least two different material layers.

28. The method of claim 21, further comprising:
integrating said plurality of miniature omni-directional corner reflectors into a binding medium.

29. The method of claim 21, wherein said plurality of miniature omni-directional corner reflectors are applied to a desired object by at least one of spraying, painting and embedding.
